(19) United States
(12) Patent Application Publication
(10) Pub. No.: US 2008/0218368 A1
(43) Pub. Date: Sep. 11, 2008

(54) Position Sensing Feedback Wireless Transmission System

(76) Inventor: Chi-Yuan CHENG, Taichung (TW)

Correspondence Address: Dr. BANGER SHIA, 102 Lindencrest Ct., Sugar Land, TX, 77479-5201, US

(21) Appl. No.: 11/683,988

(22) Filed: Mar. 8, 2007

(51) Int. Cl. G06F 13/10

(52) U.S. Cl. 340/686.5; 340/3.1

(57) ABSTRACT

A position sensing feedback wireless transmission system comprises: a movable carrier, a sensing head, a scale and a display or a controller. When the present position of the movable carrier is required to know, the sensing head can be utilized to transmit the measured information data back to the display or the controller in wireless manner. Since the position sensing feedback wireless transmission system of the present invention adopts the wireless technology, in addition to save the connecting wires cost, it can be relatively simply used in the machine. Consequently, for the design of the mechanism required to measure the long distance, the unit with a plurality of running wires can be dispensed with.

### BACKGROUND OF THE INVENTION

1. Field of the Invention

The present invention relates to a position sensing feedback device, and more particularly to a position sensing feedback wireless transmission system.

2. Description of the Prior Art

In recent years, the machining tools all develop towards the trend of microminiature, precision and nanometer-scale technology. The machining precision of the machining tools will directly influence the quality of the output products. Accordingly, sometimes the precision of the machining tools can be greatly improved by cooperating with high precision measurement instruments.

As shown in FIG. 1, a conventional position sensor comprises a sensing element 11 connected to a display 12 or a controller by a transmission line 13. Though it can precisely measure and read the position information data, strictly speaking, it still has its shortcomings. Since the transmission line 13 is needed to connect the sensing element 11 of the conventional position sensor to the position display 12, that is to say, a cable is needed to transmit the position information, thus in addition to the cable cost, a cable channel is needed to collect the cables. If the sensing element 11 is far from the position display 12, the cable cost will be more increased. Once the transmission line is excessively long, the corresponding signal intensity will consequently be reduced; even interferences will be caused to make the display obtain the wrong information.

The present invention has arisen to mitigate and/or obviate the afore-described disadvantages.

### SUMMARY OF THE INVENTION

The primary objective of the present invention is to provide a position sensing feedback wireless transmission system which can adopt the wireless technology instead of the conventional cables and can transmit the digital signals read by a sensing element to a control unit (controller or display), thus saving the cost of the cables and avoiding the problems caused by the complexity of connection.

The secondary objective of the present invention is to provide a position sensing feedback wireless transmission system which can extend the distance between the sensing element and the control unit (display or controller) without limit, due to adopting the wires transmission technology.

The third objective of the present invention is to provide a position sensing feedback wireless transmission system which can transmit a plurality of position signals back to the controller or the display in virtue of the wireless transmission communication, thus saving the cost of relevant control units (controller or display).

### BRIEF DESCRIPTION OF THE DRAWINGS

FIG. 1 is a perspective view of a conventional position sensor;

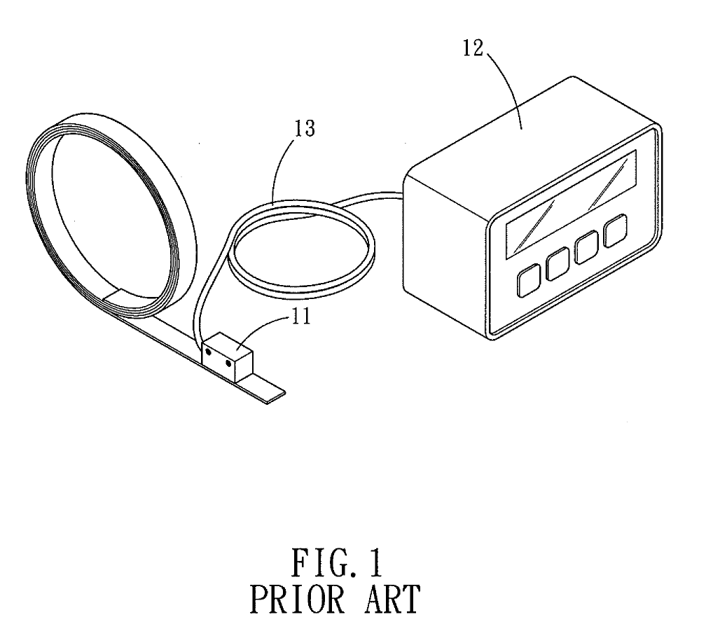

FIG. 2 is an assembly view of a position sensing feedback wireless transmission system in accordance with the present invention; and

FIG. 3 shows that a plurality of sensing heads is connected to a control unit in accordance with the present invention.

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

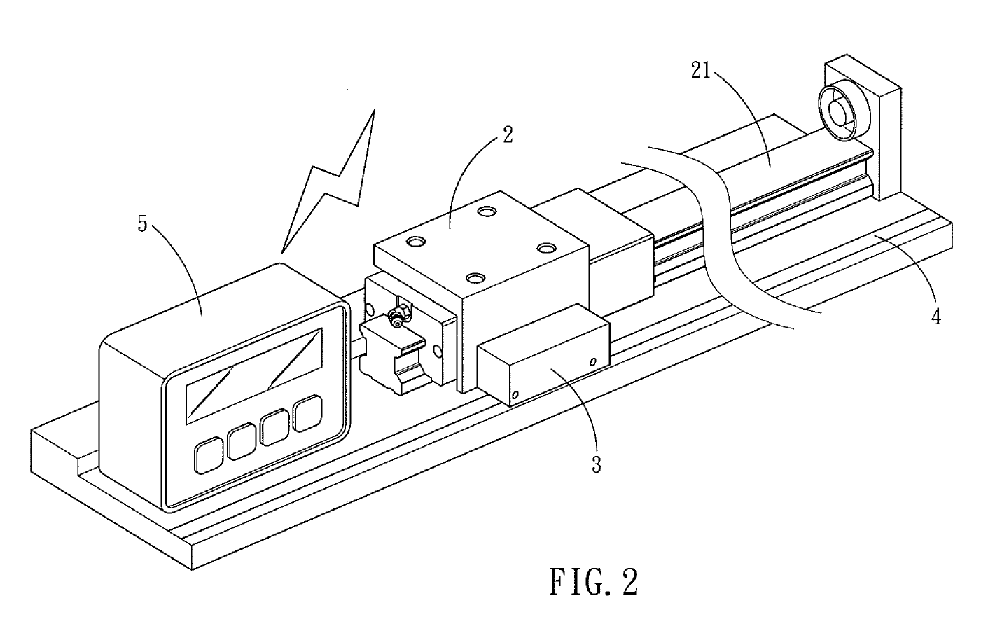

Referring to FIG. 2, a position sensing feedback wireless transmission system in accordance with a preferred embodiment of the present invention comprises a movable carrier 2, a sensing head 3, a scale 4, a control unit 5 (display or controller) etc.

The movable carrier 2 is movably mounted on a rail 21 which can be mounted on a woodworking machine or a metal cutting machine.

The sensing head 3 is mounted on the movable carrier 2 and includes a sensing element and a wireless module, once a signal is captured by the sensing element, it will be sent out by the wireless module.

The scale 4 is mounted on the movable carrier 2 and located a fixed distance away from the sensing head 3. Relevant positions can be read from the scale 4 by the sensing head 3 which can convert the position signals into digital signals, and then the wireless module will transmit the digital signals out.

The control unit 5 (display or controller) can control the movable carrier 2 or can show the position value of the movable carrier 2, by processing the data received from the wireless module, and then carry out the required positioning or the cutting operations and so on. Howsoever, the control unit 5 (display or controller) still needs to utilize the wireless module of the sensing head 3 to receive and communicate the information.

The aforementioned is the summary of the positional and structural relationship of the respective components of the preferred embodiment in accordance with the present invention. The position sensing feedback wireless transmission system in accordance with the present invention adopts the wireless transmission technology, so it can be applied to measure the long travel distance cutted by a woodworker or applied to the long distance cutting of the metal cutting machine. It is really not limited of the length and can extend the distance between the sensing element and the control unit 5 (display or controller) without limit.

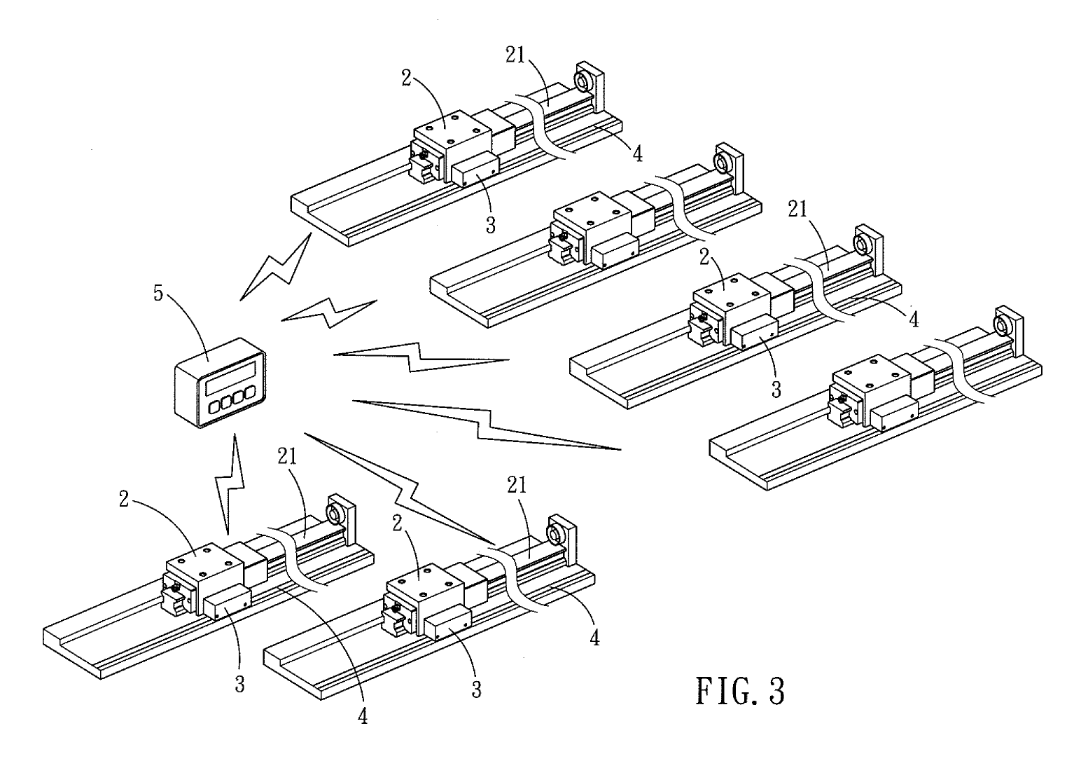

Please refer to FIG. 3, which shows that a plurality of sensing heads 3 can be connected to a control unit 5 (display or controller) via wireless communication, and at the same time a plurality of position signals is sent back to the control unit 5 (display or controller), that is to say, a plurality of position sensors can also share a control unit 5 (display or controller). The identification (ID) of the wireless transmission module only needs to be set for recognition. By such an arrangement, it can save the cost of the relevant control units 5 (display or controller).

To summarize, the structure disclosed by the preferred embodiment of the present invention can greatly facilitate the user and even can reduce the cost in virtue of the wireless transmission line design of the movable carrier and the scale.

While we have shown and described various embodiments in accordance with the present invention, it is clear to those skilled in the art that further embodiments may be made without departing from the scope of the present invention.

What is claimed is:

1. A position sensing feedback wireless transmission system comprising: a movable carrier, a sensing head, a scale and a control unit; wherein:
the movable carrier is movably mounted on a rail;
the sensing head is mounted on the movable carrier and includes a sensing element and a wireless module;
the scale is mounted on the movable carrier and located a fixed distance away from the sensing head, the sensing head reads relevant positions from the scale and coverts position signals into digital signals, and then the digital signals will be sent out by the wireless module;
the control unit serves to show a position of the movable carrier by processing the signals transmitted by the wireless module, and then carries out required positioning operation, cutting operation and so on.

2. The position sensing feedback wireless transmission system as claimed in claim 1, wherein the control unit is a display.

3. The position sensing feedback wireless transmission system as claimed in claim 1, wherein a plurality of sensing heads is connected to the control unit.

4. The position sensing feedback wireless transmission system as claimed in claim 1, wherein the control unit is a controller.
